(19) United States
(12) Patent Application Publication
(10) Pub. No.: US 2008/0245641 A1
(43) Pub. Date: Oct. 9, 2008

(54) Tamper-Proof Roller Mounting Arrangement and Method

(75) Inventor: Jonathan R. Schroeder, Roscoe, IL (US)

Correspondence Address: REINHART BOERNER VAN DEUREN P.C., 2215 PERRYGREEN WAY, ROCKFORD, IL, 61107, US

(73) Assignee: PACIFIC BEARING COMPANY, Rockford, IL (US)

(21) Appl. No.: 11/697,532

(22) Filed: Apr. 6, 2007

(51) Int. Cl. B65G 39/00

(52) U.S. Cl. 198/861.1; 193/35 J

(57) ABSTRACT

A roller-guided track apparatus is provided. The roller-guided track apparatus includes a support member and a track roller arrangement. The track roller arrangement includes an axle and a roller, with the axle having first and second axial ends thereof. The first axial end of the axle is attached to the support member in such a manner that the second axial end of the axle forms a distal end of the axle projecting away from the support member. The roller defines an inner side of the roller and an outer side of the roller and has an aperture formed therethrough configured for receiving the axle. The axle passes through the aperture of the roller such that the roller is rotatable about the axle, the inner side of the roller faces the support member, and the distal end of the axle extends beyond the outer side of the roller. The distal end of the axle is orbitally deformed to form a head for retaining the roller upon the axle.

### FIELD OF THE INVENTION

This invention generally relates to roller-guided track apparatuses and, in particular, to a precision roller-guided track apparatus.

### BACKGROUND OF THE INVENTION

A conventional roller-type linear guide apparatus, such as disclosed in U.S. Pat. No. 5,820,269 to Ariga, is employed to guide a light weight structure along a linear path. However, the conventional roller-type linear guide apparatus only suitably carries a light weight structure and is not suitable for heavier loads. Therefore, the use of these types of guide apparatuses is limited.

Other conventional roller-type linear guide apparatuses have components that are secured together by riveting. Because the riveting process generally relies on impacting an axial end of the rivet with a very large amount of force, the riveting process may cause damage to the roller assembly. For example, during impacting, components of the roller assembly might be prone to a form of brinelling, which is surface damage caused by repeated overload. If brinelling or other damage occurs, divots or notches may be formed in surface that the bearings travel over and along. If this occurs, operation of the roller-type linear guide is rather rough.

To overcome these and other drawbacks, the industry has migrated toward using linear rail systems having a threaded roller assembly as depicted in U.S. Pat. Nos. 6,149,308 and 6,450,687 to Schroeder, et al., and U.S. Pat. No. 5,531,137 to Guilford. The threaded roller assembly has an axle with a threaded end. The threaded end is threadably driven into, for example, a slider body having mating threads. As such the roller assembly is well supported.

While the threaded roller assemblies noted above work quite well for their intended applications, there are other applications where it would be desirable to eliminate the threads on the axle. In some circumstances, an axle bearing threads may be somewhat weakened compared to a non-threaded axle. This is because material it usually removed and the diameter of the axle is reduced when forming the threads. In addition, during the threading process, the hardening of the axle is partially stripped away. By removing the hardening from a portion of the axle, the benefits of that process are lost. As another drawback, an axle with threads may be more susceptible to cycle stress, fatigue, and vibration. Moreover, a threaded axle may be prone to over tightening, which will likely damage the axle and any threaded mating component.

There exists, therefore, a need in the art for a tamper-proof roller mounting arrangement and method that overcomes one or more of the above-noted drawbacks. The invention provides such an arrangement and method. These and other advantages of the invention, as well as additional inventive features, will be apparent from the description of the invention provided herein.

### BRIEF SUMMARY OF THE INVENTION

A roller-guided track apparatus is provided. The roller-guided track apparatus prevents or discourages tampering and is constructed using a process that is generally inexpensive and completely relatively quickly. The roller-guided track apparatus is also uniquely configured to prevent components of the apparatus from undesirably coming apart after they have been secured together.

In one embodiment, a method of mounting a track roller arrangement to a support member is provided. The track roller arrangement includes an axle and a roller. The method includes the steps of attaching a first portion of the axle to the support member, passing a second portion of the axle through the roller, and orbitally deforming the second portion of the axle to secure the roller onto the axle.

In one embodiment, a roller-guided track apparatus is constructed according to the above noted method. The roller-guided track apparatus includes a support member and a track roller arrangement. The track roller arrangement includes an axle and a roller, with the axle having first and second axial ends thereof. The first axial end of the axle is attached to the support member in such a manner that the second axial end of the axle forms a distal end of the axle projecting away from the support member. The roller defines an inner side of the roller and an outer side of the roller and has an aperture formed therethrough configured for receiving the axle. The axle passes through the aperture of the roller such that the roller is rotatable about the axle, the inner side of the roller faces the support member, and the distal end of the axle extends beyond the outer side of the roller. The distal end of the axle is orbitally deformed to form a head for retaining the roller upon the axle.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partially exploded view of an exemplary embodiment of a roller-guided track apparatus in accordance with the teachings of the present invention, the roller-guided track apparatus oriented proximate a channel;

FIG. 2 is a front elevation view of the roller-guided track apparatus of FIG. 1;

FIG. 3 is a side elevation view of the roller-guided track apparatus of FIG. 1 prior to a free end of the axle being subjected to an orbital forming process;

FIG. 4 is a side elevation view of the roller-guided track apparatus of FIG. 1 after the free end of the axle has been orbitally formed;

FIG. 5 is a top view of the roller-guided track apparatus of FIG. 1 highlighting a set screw and a pair of wipers; and

FIG. 6 is another embodiment of a roller-guided track apparatus formed by the orbital forming process.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

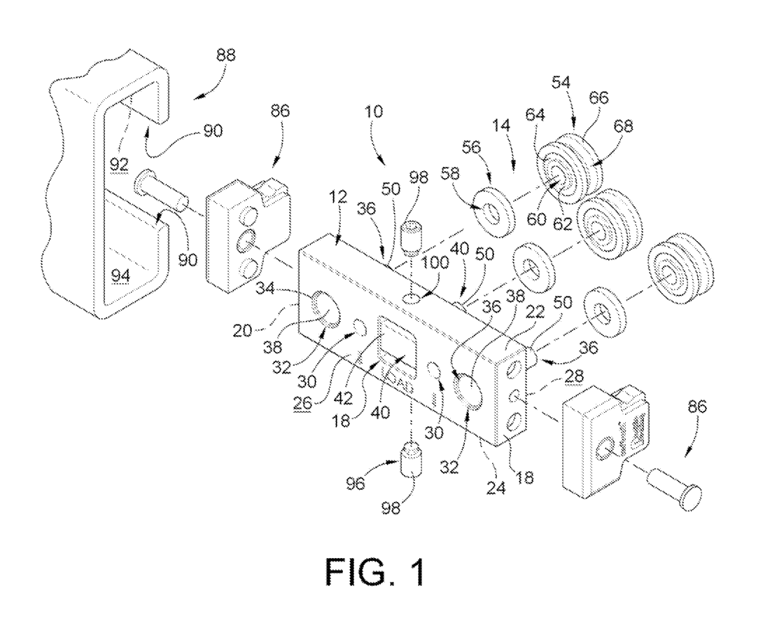

Referring to FIG. 1, a roller-guided track apparatus 10 is illustrated. As will be more fully explained below, the roller-guided track apparatus 10 is constructed in a manner that prevents or discourages tampering. In addition, the roller-guided track apparatus 10 is constructed using a process that is generally inexpensive and that can be completed relatively quickly. The roller-guided track apparatus 10 is also uniquely configured to prevent components of the roller-guided track apparatus from undesirably coming apart after they have been secured to each other. As shown in FIG. 1, the roller-guided track apparatus 10 comprises a support member 12 and a track roller arrangement 14.

In the illustrated embodiment of FIG. 1, the support member 12 is a slider body, which may also be described as a carriage or shuttle. As shown, the support member 12 includes a central aperture 16 disposed about an equal distance from each side 18, 20 and the top and bottom 22, 24 of the slider body 12. The central aperture 18 generally passes through the slider body 12 from a front surface 26 to the back surface 28. The particular configuration of the central aperture 18 will be more fully explained below.

Spaced outwardly from the central aperture 18 toward the sides 18, 20 are two small round apertures 30. The small round apertures 30 pass entirely through the slider body 12 from the front surface 26 to the back surface 28. These apertures 30 are sized and dimensioned to receive a screw, bolt, or other suitable connector such that the slider body 12 may be secured to, for example, a drawer in a piece of furniture (not shown).

Set outwardly from the two small apertures 30 toward the sides 18, 20 are two larger round apertures 32. Like the small round apertures 30, the large apertures 32 pass entirely through the slider body 12 from the front surface 26 to the back surface 28. In the illustrated embodiment, a portion of slider body 12 around the large round apertures 32 is angled inwardly to form a countersink 34.

Each of the large round apertures 32 is sized and dimensioned to receive an axle 36 (a.k.a., spindle, shaft, etc.) from the track roller arrangement 14. In the illustrated embodiment, each of the axles 36 includes an outwardly flared end 38. When each of the axles 36 is inserted into one of the large round apertures 32, the flared end 38 generally engages the countersink 34 in the slider body 12 to prevent the axle 36 from being pulled entirely through the slider body 12. In the illustrated embodiment of FIG. 1, the flared ends 38 of the axles 36 are disposed slightly beneath the front surface 26 of the slider body 12. In other words, in the illustrated embodiment the flared ends 38 are not flush with the front surface 26 of the slider body 12.

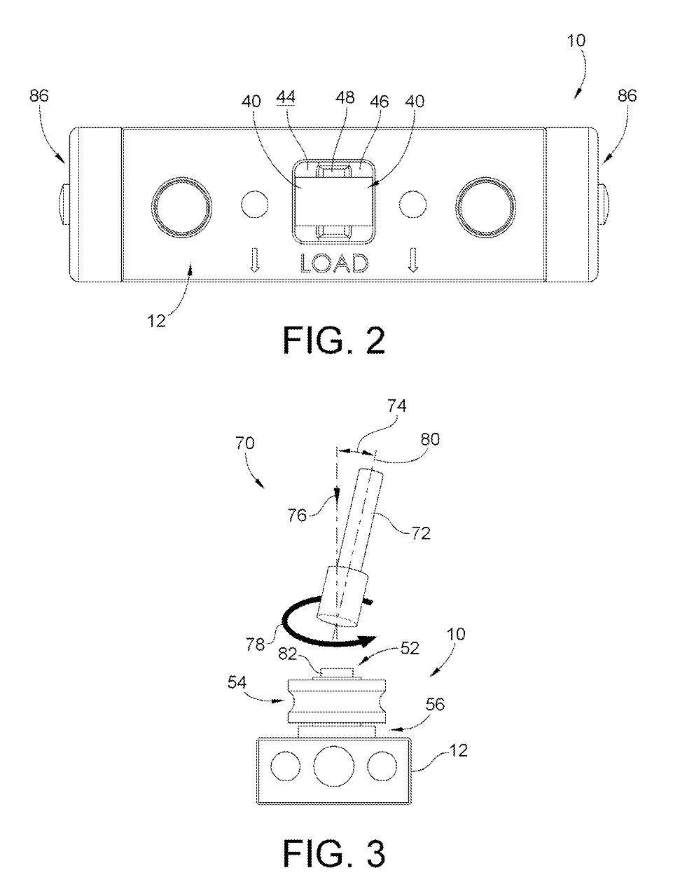

As shown in FIG. 2, the axle 40 seated in the central aperture 18 has a generally rectangular end 42. In the illustrated embodiment, the long side of the rectangular end 42 progresses toward each of the sides 18, 20 of the slider body 12. The short side of the rectangular end 42 has a length that is somewhat less than the side dimension of the central aperture 18. Therefore, as will be more fully explained below, the axle 40 is able to move vertically (i.e., up and down) within the central aperture 18 relative to the top and bottom surfaces 22, 24 of the slider body 12.

As shown in FIG. 2, the rectangular end 42 of the axle 40 seats against an inner surface 44 of a back wall 46 of the slider body 12. The inner surface 44 of the back wall 46 is the surface that generally opposes the back surface 28 shown in FIG. 1. The back wall 46 of the slider body 12 forms a rectangular slot 48 oriented with a long side progressing toward the top and bottom 22, 24 of the slider body 12. Therefore, the rectangular slot 48 is oriented about ninety degrees away from the rectangular end 42 of the axle 40. Therefore, when the axle 40 is disposed within the central aperture 18, the axle passes through the rectangular slot 48 and the rectangular end 42 engages the inner surface 44 of the back wall 46 in the slider body 12 and prevents the axle 40 from being pulled entirely through the central aperture 18.

Because the inner surface 44 of the back wall 46 is spaced further away from the front surface 26 of the slider body 12 than a thickness of the rectangular end 42 of the axle 40, the rectangular end of the axle is disposed slightly beneath the front surface of the slider body. In other words, in the illustrated embodiment the rectangular end 42 is not flush with the front surface 26 of the slider body 12.

While the rectangular and flared ends 36, 42 of the axles 38, 40 are quite different from each other, the central portion 50 and free end 52 of each of the axles 36, 40, represented in FIG. 3 generally has the same cylindrical or axial shape. While the axles 36, 40 may be formed from a hollow cylinder, the axles in the illustrated embodiment of FIG. 1 are solid. As depicted in FIG. 1, some of the central portion 50 and a free end 52 of each of the axles 36, 40 project away, and extend outwardly, from the back surface 28 of the slider body 12. Therefore, the free ends 52 form a distal end. As will be more fully explained below, the distance that the axles 36, 40, and particularly the free ends 52, extend from the slider body 12 depends on the size and dimension of a roller 54 and, if one is included, a washer 56 (a.k.a., a spacer) of the track roller arrangement 14.

Before any work is performed on them, the free ends 52 are sized and dimensioned to pass through a central aperture 58 of the washer 56. Once the washer 56 has been placed on the axle 36, 40, the free end 52 is inserted through a central aperture 60 of an inner race 62 of the roller 54 such that the free end 52 is press fit to the inner race 62. Therefore, as depicted in FIG. 3, the free end 52 projects out of the central aperture 60 of the inner race 62. Also, the inner race 62, the washer 56, and the slider body 12 are engaged with each other. Even so, the outer race 64 and roller wheel 66 are still able to freely rotate.

As those skilled in the art know, and as shown in FIG. 1, the inner race 62 of the roller 54 is engaged with an outer race 64 by, for example, bearings (not shown). Therefore, due to the bearings, the inner and outer races 62, 64 are able to move relative to one another. As a result, when the inner race 62 is secured in place, the outer race 64 is still able to rotate about the axle 36, 40. When a roller wheel 66 having, for example, a central groove 68 is fitted to or around the outer race 64, the roller wheel 66 rotates along with the outer race 64 and relative to the inner race 62.

Once the axles 36, 40 have been placed in the slider body 12 and the free ends 52 passed through the washer 56 and the roller 54 as shown in FIG. 3, an axial center of the free ends are located and the free ends are subjected to an orbital forming process 70 (a.k.a., radial riveting, spin riveting, etc.). Orbital forming is a cold forming process whereby an orbiting tool 72 held at a fixed angle 74, typically three to six degrees, is used to progressively transform malleable material into a desired, predetermined shape.

Advantageously, the orbital forming process 70 may be used to head, swage, crown, flare or draw a column or projection of material. The orbital forming process 70 is used to produce a high quality head without disrupting the component material grain structure. While similar in nature to impact or compression forming and riveting in that a compressive axial load 76 is applied to the part being formed, the axial load 76 is greatly reduced due to the mechanical advantage of the angular orbiting tool 72 and progressive forming action 78. The axial load 76 required for forming is reduced up to eight percent (80%) with the orbital forming process 70 due to this mechanical advantage.

The drastic reduction in compressive axial load 76 when using the orbital forming process 70 as opposed to an impact forming process has several distinct advantages: For one, most of the work during the orbit forming process 70 occurs at the orbiting tool's line of contact 80. Internal stress loads, caused by a high compressive axial load 76 applied to the assembled components, are greatly reduced. Forming work is focused and the component being deformed sees less stress. In addition, mating parts experience less stress as well. Therefore, there is no brinelling or other damage to the components being worked upon.

In addition, the orbital forming process 70 is able to produce a smoothly finished surface on the free ends 52. In some cases, the orbital forming process 70 is able to eliminate cracks that could not be avoided with impact riveting. Also, cold head forming without bending or swelling of a column is achieved since the effective forming load does not typically exceed the column strength. Further, less axial load (up to 80% reduction) required for forming results in much lighter press requirements. On larger parts, equipment tonnage, floor space and cost are greatly reduced.

Because of the lower forming force requirements with the orbital forming process 70, less rigid fixturing is required, which reduces initial tooling costs. Also, due to lower forming forces, tool and fixturing life are much longer and expendable tooling costs are greatly reduced. In addition, as one of the orbital forming process 70 synonyms (noiseless riveting) implies, the orbital forming process is much quieter than other cold forming processes such as impact forming or peening.

Cycle time for the orbital forming process 70 (i.e., the time needed to complete the progressive forming action 78) can vary greatly depending on the application. Typical cycle time to advance, form and retract is about one and a half to about three seconds (1.5 to 3.0 s). Cycle time is generally determined by the type of material being formed, material diameter, formed head configuration, and stroke required.

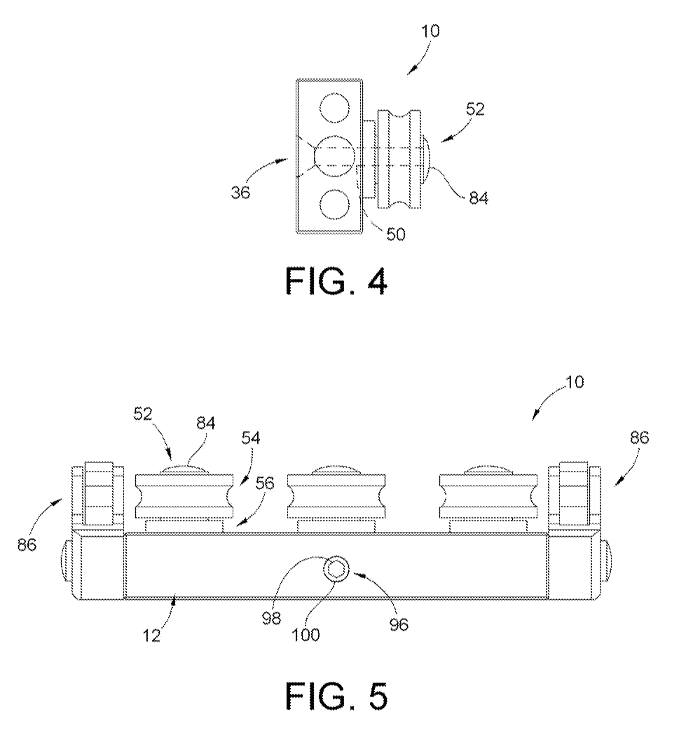

Referring now to FIG. 3, during the orbital forming process 70 used to form the roller-guided track apparatus 10, the free end 52 of the axles 36, 40 is deformed from a generally cylindrical shape 82 as shown in FIG. 3 to a deformed shape 84 (a.k.a., a head) as depicted in FIG. 4. Despite the deformed shape 84 being a generally cylindrical shape in FIG. 4, the deformed shape may be any of the shapes noted above.

As shown in FIG. 4, after having been worked on, the free end 52 of the axle 36, 40 extends radially outwardly further than the central portion 50 (FIG. 3) of the axles. In order to accept such deformation, the axles 36, 40 are generally formed from a malleable material including, but not limited to, mild steel, most alloys such as stainless steel, heat-treated steels, case hardened materials and non-ferrous metals such as aluminum, brass, copper. In addition, the axles 36, 40 may also be formed from other suitable materials such as, for example, plastic.

After the orbital forming process 70 has been performed, the washer 56, slider body 12, and the inner race 62 are tightly engaged with each other. As such, relative movement between these components is prevented. However, the outer race 64 and roller wheel 66 are still able to rotate about the axle 36, 40. The nature of the orbital forming process 70 permits the amount of deformation of the free ends 52 and the axial length of the axles 36, 40 to be precisely controlled.

As shown in FIGS. 1, 2 and 5, either before or after the orbital forming process takes place, wipers 86 can be added to either side 18, 20 of the slider body 12. The wipers 86 are linearly aligned with the rollers 54 and employed to wipe clean the channel 88 (FIG. 1) when the slider body 12 is inserted therein. When the slider body 12 is disposed in the channel 88, the groove 68 of each of the rollers 54 is aligned with one of the rims 90 on the channel and the slider body is positioned between the inner top and bottom surfaces 92, 94 of the channel 88. Therefore, the slider body 12 generally travels within the channel 88.

To facilitate the insertion and removal of the slider body 12 from within the channel 88, in the illustrated embodiment of FIGS. 1 and 5 the slider body 12 includes an adjustment mechanism 96 that operates in conjunction with the axle 40 of the centrally located track roller arrangement 14. The adjustment mechanism 96 may be, for example, one of the adjustment mechanisms disclosed in U.S. Pat. Nos. 6,149,308 and 6,450,687 to Schroeder, et al., each of which is incorporated herein in its entirety.

In the illustrated embodiment, the adjustment mechanism 96 includes a pair of set screws 98 threaded into apertures 100 formed through the top and bottom 22, 24 of the slider body 12 as shown in FIGS. 1 and 5. By threadably driving the set screws 98 into or out of the slider body 12, the central track roller arrangement 14 is moved vertically upwardly or downwardly. As a result, the axle 40 moves upwardly or downwardly within the rectangular slot 48. In addition, the roller wheel 66 associated with that track roller arrangement 14 moves upwardly and downwardly with the axle 40.

When the slider body 12 is placed in the channel 88, the roller wheel 66 of each outside track roller arrangement 14 is seated on the bottom rim 90 of the channel. Thereafter, the set screws 98 are manipulated to move the roller wheel 66 on the central track roller arrangement 14 upwardly until the roller wheel contacts the upper rim 90 of the channel 88. If the set screws 98 are properly positioned, the outside roller wheels 66 exert a downward force on the bottom rim 90 of the channel 88 and the inside roller wheel 66 exerts an upward force on the upper rim 90. In this manner, the slider body 12 is held within the channel 88. To remove the slider body 12 from the channel 88, the set screws 98 are backed off until the roller wheel 66 of the inner track roller arrangement 14 pulls away from the upper rim 90.

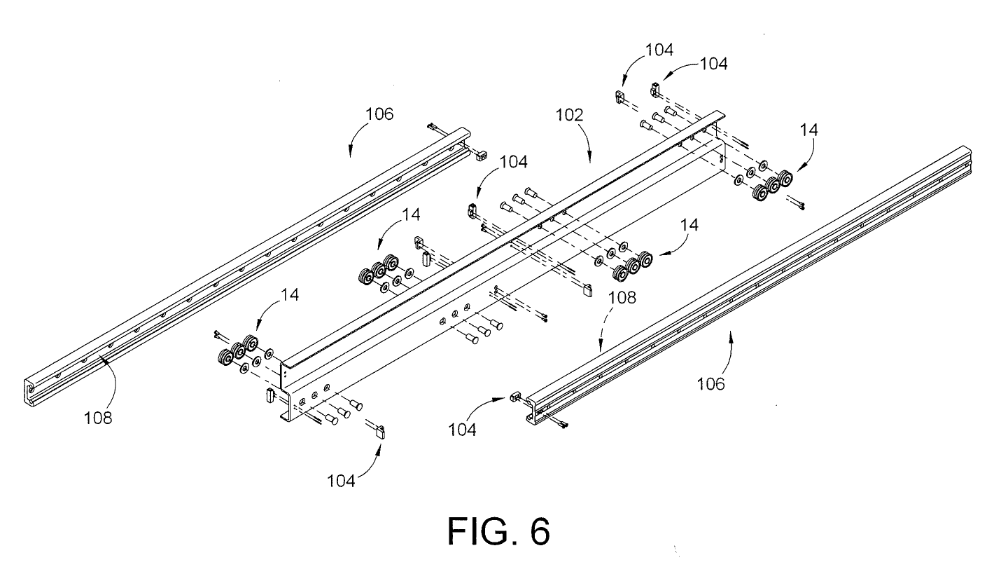

In one embodiment as shown in FIG. 6, the support member 102 is a rail. In this embodiment, several of the track roller assemblies 14 are secured to the support member 102 in opposing directions by the orbital forming process 70 described above. Thereafter, stops 104 are secured to the support member 102 and the track roller assemblies 14 are engaged with bumpers 106 disposed on either side of the support member 102. The roller wheel 66 of each track roller arrangement 14 generally rides in the channel 108 of the bumper 106. In other words, the support member 102 is sandwiched between the bumpers 106. When assembled, the support member 102 slides relative to each of the bumpers 106. Therefore, when attached to, for example, a drawer in a piece of furniture, the drawer may be easily and fluidly moved between open and closed positions.

From the foregoing, those skilled in the art will recognize that the roller-guided track apparatus 10 disclosed herein provides prevents or discourages tampering. In addition, the roller-guided track apparatus 10 is constructed using a process that is generally inexpensive and that can be completed relatively quickly. The roller-guided track apparatus 10 is also uniquely configured to prevent components of the roller-guided track apparatus from undesirably coming apart after they have been secured to each other.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A roller-guided track apparatus, comprising:
a support member; and
a track roller arrangement;
the track roller arrangement including an axle and a roller, with the axle having first and second axial ends thereof;
the first axial end of the axle being attached to the support member in such a manner that the second axial end of the axle forms a distal end of the axle projecting away from the support member;
the roller defining inner side of the roller and an outer side of the roller, and having an aperture formed therethrough configured for receiving the axle;
the axle passing through the aperture of the roller such that the roller is rotatable about the axle, the inner side of the roller faces the support member, and the distal end of the axle extends beyond the outer side of the roller;
the distal end of the axle being orbitally deformed to form a head for retaining the roller upon the axle.

2. The roller-guided track apparatus of claim 1, wherein the distal end of the axle is orbitally deformed to a predetermined axial length of the axle.

3. The roller-guided track apparatus of claim 1, wherein the distal end is orbitally deformed a predetermined amount.

4. The roller-guided track apparatus of claim 1, wherein the first end of the axle is outwardly flared and an aperture formed in a side of the support member opposite the roller is countersunk, the outwardly flared first end of the axle seated within the countersunk aperture.

5. The roller-guided track apparatus of claim 1, wherein the orbitally deformed distal end of the axle extends radially outwardly further than a central portion of the axle passing through the aperture of the roller.

6. The roller-guided track apparatus of claim 1, wherein the support member is a slider body configured to travel within a channel.

7. The roller-guided track apparatus of claim 6, wherein the slider body supports wipers at opposing ends, the wipers linearly aligned with the roller.

8. The roller-guided track apparatus of claim 1, wherein the support body includes an adjustment member, the adjustment member engaging the axle such that the roller is vertically adjustable relative to the support member.

9. The roller-guided track apparatus of claim 1, wherein the roller-guided track apparatus includes a plurality of additional track roller assemblies constructed in the same fashion as the track roller arrangement, the track roller arrangement and the plurality of additional track roller assemblies projecting away from the support member in opposing directions, and wherein the support member is a rail interposed between bumpers, the track roller arrangement and the plurality of additional track roller assemblies engaging the bumpers.

10. The roller-guided track apparatus of claim 1, wherein the track roller arrangement further includes a washer, the washer surrounding the axle and interposed between the roller and the support member.

11. The roller-guided track apparatus of claim 1, wherein the axle is formed from a solid shaft of malleable material.

12. A method of mounting a track roller arrangement to a support member, the track roller arrangement including an axle and a roller, comprising the steps of:
attaching a first portion of the axle to the support member;
passing a second portion of the axle through the roller; and
orbitally deforming the second portion of the axle to secure the roller onto the axle.

13. The method of claim 12, wherein the method further comprises the step of limiting an extent of deformation during the orbitally deforming step.

14. The method of claim 12, wherein the method further comprises locating an axial center of the second portion prior to orbitally deforming the second portion.

15. The method of claim 12, wherein the method further comprises the step of vertically adjusting the roller relative to the support member.

16. A method of forming a roller-guided track apparatus, the method comprising the steps of:
orbitally deforming a free end of a plurality of track roller assemblies to secure the track roller assemblies to a support member;
inserting the track roller assemblies into a channel; and
vertically adjusting one of the track roller assemblies such that the support member is releasably locked in the channel.

17. The method of claim 16, wherein the method further comprises the step of inserting the free end through the support member and subsequently through a roller prior to the step of orbital forming.

18. The method of claim 17, wherein the method further comprises the step of inserting the free end through a washer such that the washer is interposed between the roller and the support member.

19. The method of claim 18, wherein the method further comprises orbitally deforming a second free end of a second plurality of track roller assemblies to secure the second track roller assemblies to the support member, the first and second plurality of track roller assemblies projecting away from the support member in generally opposing directions and received within bumper assemblies on opposing sides of the support member.

20. The method of claim 15, wherein the step of orbitally deforming is performed by deforming a solid malleable metal axle.
